(19) United States
(12) Patent Application Publication
(10) Pub. No.: US 2011/0000210 A1
(43) Pub. Date: Jan. 6, 2011

(54) Integrated System for Using Thermal Energy Conversion

(76) Inventor: Mark W. Miles, Atlanta, GA (US)

Correspondence Address: HAHN AND MOODLEY, LLP, 3333 Bowers Avenue, Suite 130, Santa Clara, CA, 95054, US

(21) Appl. No.: 12/495,858

(22) Filed: Jul. 1, 2009

(51) Int. Cl. F03G 4/00; F01K 13/00; F03G 6/00

(52) U.S. Cl. 60/641.2; 60/645; 60/641.8; 60/643

(57) ABSTRACT

In one embodiment, the invention provides a method for using heat to perform work, comprising: operating a first thermodynamic cycle wherein heat for a first working fluid is provided by combustion of a fuel-based (FB) energy source; operating a second thermodynamic cycle wherein heat for a second working fluid is from a combination of a non-fuel-based (NFB) energy source and waste heat from the first thermodynamic cycle.

### FIELD

Embodiments of the invention relate energy systems based on a geothermal heat sources.

### BACKGROUND

Thermodynamic cycles such as the Rankin cycle or a derivative thereof such as the Organic Rankin cycle (ORC) use heat or thermal energy to heat a working fluid that can then be used to perform work, e.g. driving a turbine to produce electricity.

The heat to drive the aforesaid thermodynamic cycles may be obtained from a geothermal heat/energy source where it is extracted from a hot geo-fluid that percolates from the earth.

Geothermal heat sources vary in grade from high to low. High grade geothermal heat sources are characterized in they have high temperature geo-fluids (>100° C.) with high flow rates (>2000 liters/minute). Low grade geothermal heat sources have low temperature geo-fluids (<100° C.) with flow rates <1000 liters/minute.

Low grade geothermal heat sources may be not be suitable to provide the heat to drive thermodynamic cycles.

### SUMMARY

Generally, embodiments of the present invention disclose a method and apparatus to utilize a low grade geothermal heat source to supply heat to a first thermodynamic cycle. The method may comprise boosting or supplementing the heat being supplied to the first thermodynamic cycle by feeding waste heat from a second thermodynamic cycle into the first thermodynamic cycle. The second thermodynamic cycle may be driven by heat derived through combustion of a fuel. Advantageously, the second thermodynamic cycle may be operated to service a location e.g., a hotel, by providing heating and/or cooling at the location.

Specifically, in one aspect the invention provides a method for using heat to perform work, comprising: operating a first thermodynamic cycle wherein heat for a first working is provided by combustion of a fuel-based (FB) energy source; operating a second thermodynamic cycle wherein heat for a second working fluid is from a combination of a non-fuel-based (NFB) energy source and waste heat from the first thermodynamic cycle.

Specifically, in another aspect, the invention provides a method for using heat to perform work, comprising: modifying an existing installation that operates a first thermodynamic cycle so that waste heat from said thermodynamic cycle can be fed into a second thermodynamic cycle, wherein said first thermodynamic cycle relies on combustion of an fuel-based (FB) energy source to heat a first working fluid; and constructing a new installation to operate the second thermodynamic cycle wherein a second working fluid is heated by a combination of a non-fuel-based (NFB) energy source and the waste heat from the first thermodynamic cycle.

Specifically, in yet another aspect, the invention provides apparatus to convert heat into energy, comprising: a first sub-system to operate a first thermodynamic cycle to harness heat derived through combustion of a fuel-based (FB) energy source; and a second sub-system to operate a second thermodynamic cycle to harness heat derived from a combination of a non-fuel-based (NFB) energy source and waste heat from the first sub-system.

Other aspects of the invention will be apparent from the written description below.

### BRIEF DESCRIPTION OF THE DRAWINGS

FIG. 1 of the drawings shows a schematic representation of a fuel based energy conversion system.

FIG. 2 of the drawings shows a schematic representation of an organic Rankin cycle (ORC) based energy conversion system driven by geothermal and/or solar heat sources.

FIG. 3 of the drawings shows a schematic representation of a combined ORC and fuel based energy conversion system, in accordance with one embodiment of the invention

FIG. 4 of the drawings shows detail of the electricity generating subsystems of the energy conversion system illustrated in FIG. 3.

FIG. 5 of the drawings is a temperature entropy diagram for the working fluid HFC134a.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention discloses, in one embodiment, a system for the conversion of heat into usable energy in the form of electricity, in the form of a heating medium (a fluid including but not limited to water), and in the form of a coolant medium (another fluid including but not limited to water). The electricity may be used to drive electrical appliances such as is found in a residence, a commercial entity, or a factory. The heating medium may be used to provide space heating and hot water to a facility. The coolant medium may be used to supply a cooling supply to air conditioning units in the same settings.

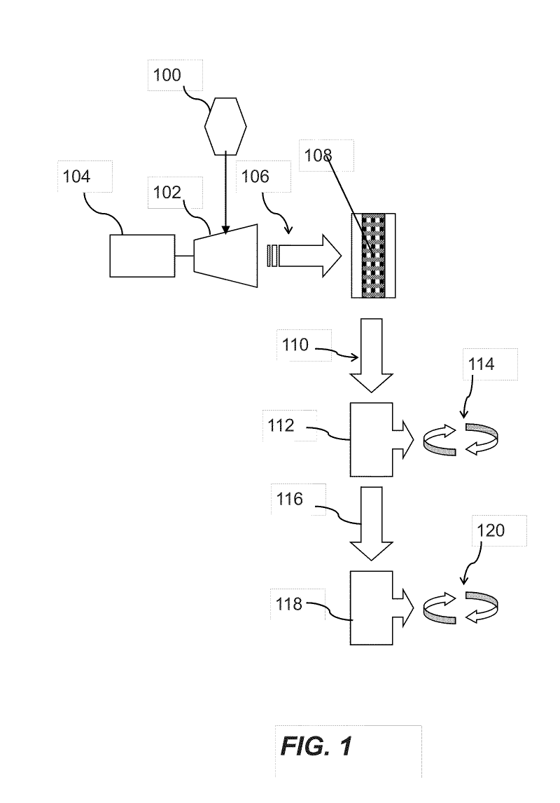

Referring to FIG. 1, a thermal energy conversion system is shown which derives energy from a fuel source 100. The fuel is combusted in prime mover 102, which is usually in the form of a turbine or reciprocating engine. A prime mover is a mechanical component which can convert the kinetic energy of an expanding gas into rotational or translational motion. Fuels include but are not limited to a variety of combustible fluids or gasses such as kerosene, natural gas, methane, hydrogen, fuel oil, and diesel fuel. Rotational shaft power from prime mover 102 is coupled to generator 104 where it produces electricity. Exhaust heat, in the form of exhaust gasses (as well as prime mover cooling fluid in the case of a reciprocating engine as prime mover) supply heat 106, to heat exchanger 108. A heat exchanger is a component for transferring heat between two different gaseous and/or liquid mediums. This component is in standard use within the industry of heat transfer and is readily designed and manufactured by those skilled in the art.

Heat exchanger 108 extracts some portion 110, of waste heat 106, and transfers it to distributor 112 and absorption chiller 118 via heat flows 110 and 116. This heat transfer can occur via one or more mechanisms such as the flow of a fluid medium, or via a heat pipe in a fashion which was disclosed in patent application Ser. No. 12/396,336 which is herein incorporated by reference. Distributor 112 provides some useful heat output via a heating medium circulation loop 114, for use in facilities which may require space heating or for some other purpose. Circulation loop 114 could include a network of pipes or heat pipes which carry liquids (such as water) or vapors (such as steam) to carry the heat to areas where it is needed.

Absorption chiller 118 (or some other mechanism for converting heat into cooling capacity) provides some useful cooling capacity via coolant medium circulation loop 120. Circulation 120 loop could include a network of pipes or heat pipes which carry liquids (such as water) or vapors (such as steam) to extract heat from areas where it is appropriate. In general all heat flows, heat transfers, or circulation loops within and outside the system described in this application can be accomplished using conventional piping networks or networks of heat pipes depending on the application in a manner described in patent application Ser. No. 12/396,336.

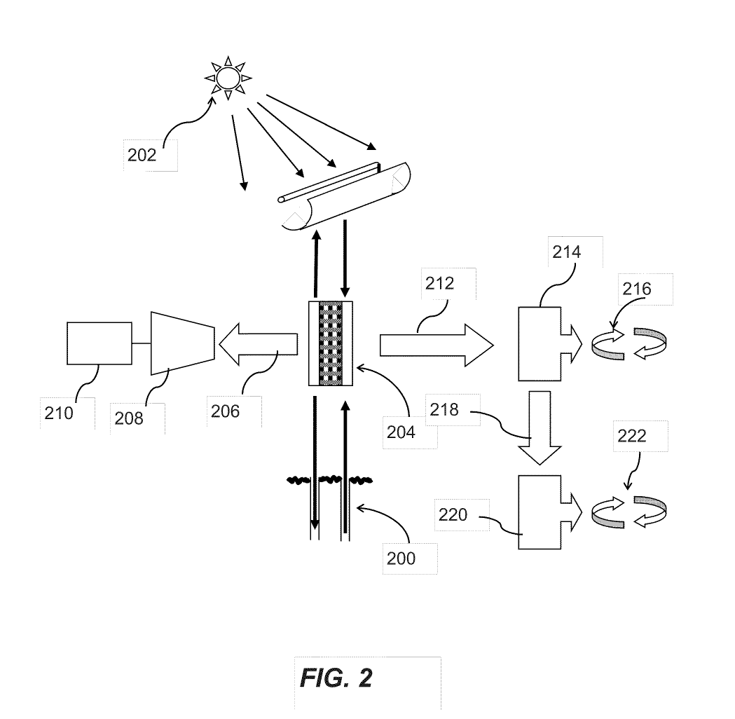

Referring to FIG. 2, thermal sources 200 and 202 provide heat to heat exchanger 204. Thermal source 200 is in the form of a geothermal heat source which extracts heat from the earth via the circulation or extraction of a geo-fluid within or from the interior of the earth. Thermal source 202 is the sun whose energy can be collected in a variety of ways known to those skilled in the art.

Methods for extracting this heat are described in patent application Ser. No. 12/396,336. A portion of the heat delivered to heat exchanger 204, heat flow 206, is used to drive ORC engine 208. Rotational shaft power developed by ORC engine 208 is used to drive generator 210 to produce electricity. Another portion of the heat from heat exchanger 204 is extracted in the form of heat flow 212. This heat is delivered to distributor 214, and chiller 220, which serve the same function as distributor 112, and chiller 118 in FIG. 1.

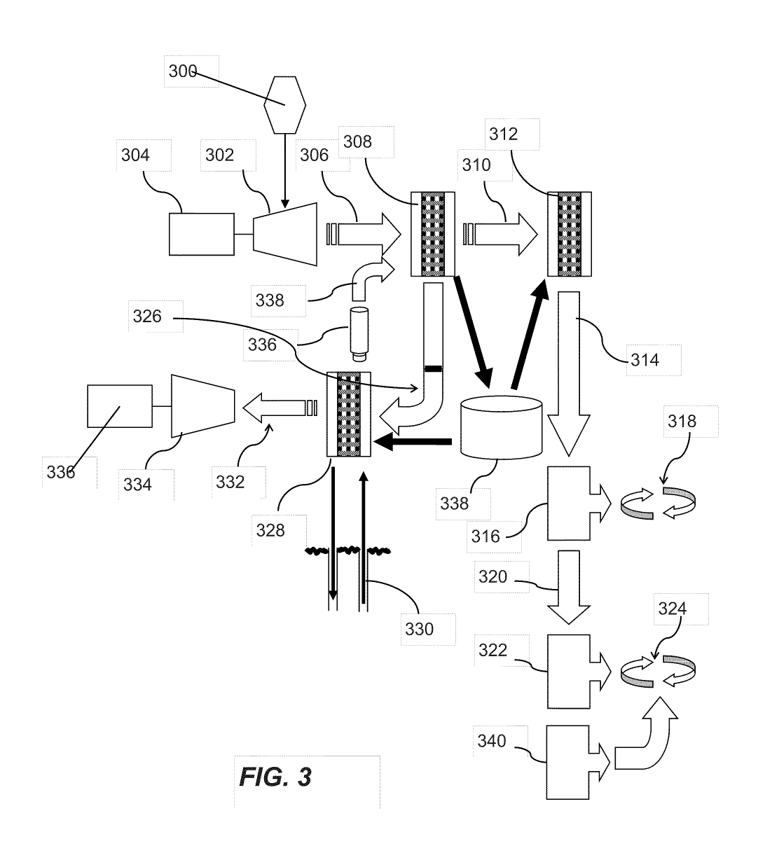

Referring now to FIG. 3, fuel source 300 supplies fuel to prime mover where it is combusted. Rotational shaft power drives generator 304 to produce electricity. Exhaust heat 306 is transferred to heat exchanger 308, where some heat is extracted, and the remaining heat transferred to heat exchanger 312. The positions of these two heat exchangers may be switched depending on the design of the system and components. They may also consolidate into a single heat exchanger. Heat exchangers 308 and 312 may be a variation of a standard tube and fin configuration which is well understood by those skilled in the art. Enhanced performance of these heat exchangers may be achieved if an alternative design utilizing graphite (carbon based) foam materials is incorporated. Heat exchangers using this technology are described in the paper “Thermal Management Solutions Utilizing High Thermal Conductivity Graphite Foams” which is herein incorporated by reference. These foam exhibits increased surface areas and high thermal conductivities, thus their incorporation can lead to smaller more efficient heat exchange between two or more fluid and gaseous mediums. Heat exchanger 312 extracts a portion of the heat contained within heat flow 310, and directs it to distributor 316, and chiller 322. Electric chiller 340 is shown supplying supplemental cooling capacity to coolant loop 324. Under certain operational circumstances, overall system efficiency may be improved if some fraction of the cooling capacity is supplied indirectly from electricity via this chiller.

Heat exchanger 308 extracts a portion of heat flow 306, and transfers it via heat flow 326 to heat exchanger 328. Heat flow 326 may be accomplished via circulating fluid medium or heat pipe. Heat exchanger 328 serves to combine heat flow 326, with heat derived from geothermal heat source 330. Other heat sources may be combined but are not shown here for purposes of simplification. The combined heat flow 332, is transferred to ORC engine 334 which produces shaft power used to drive generator 336, producing electricity. Heat exchanger 308 may also supply heat to thermal storage unit 338 under circumstances when all available heat is not required.

Referring again to FIG. 3, thermal storage can be provided via a number of technologies some of which are described by the aforementioned patent application Ser. No. 12/396,336. The heat stored may be re-injected into the system via heat exchangers 312 or 328 in this case.

Booster burner 336 is shown providing supplementary heat flow 338 to heat exchanger 308. Prime mover 302, if is in the form of a turbine, is generally constrained to operate at one speed with a constant fuel consumption rate in order to maintain optimum efficiency. In circumstances where additional fuel based heat is required to optimize the overall system performance then booster burner 338 may be engaged to supply varying amounts of additional heat to supply this need.

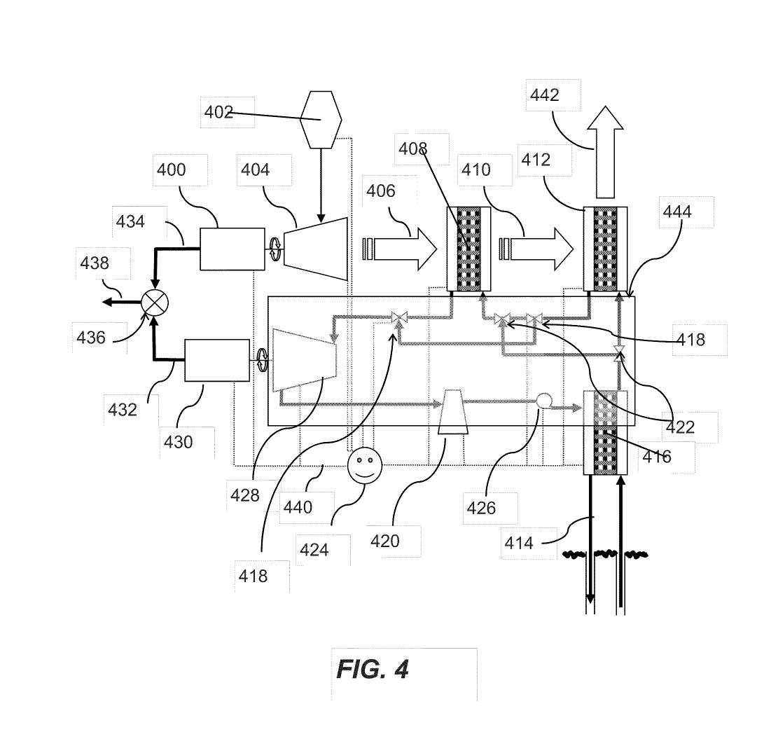

Referring now to FIG. 4, electricity 438 results from the combined electrical outputs 434 and 432, which are combined using electronic circuitry 436. This kind of circuitry can also provide a proper interface to an electrical grid that adheres to the requirements of such a grid, and can be easily designed by someone skilled in the art. The electricity is produced by generators 400 and 430. Generator 400 is driven directly by prime mover 404, which derives its energy from the combustion of fuel from fuel source 402. Generator 430 is driven by prime mover 428, which derives its energy from the heat supplied to it from some combination of heat exchangers 408, 412, and 416. Heat exchanger 442, also supplies heat flow 442 which can be used externally for heating and cooling as discussed above. Heat exchanger 408 extracts heat from exhaust heat flow 406, while heat exchanger 416 extracts heat from one or more sources which could include thermal storage, solar thermal, and geothermal heat sources, the being latter be illustrated here. Region 444 shows detail of the ORC engine represented in FIGS. 2 and 3, and detail on the working fluid loop. For purposes of this discussion the working fluid is the refrigerant HFC134a, a well known fluid though other refrigerants (such as ammonia) and hydrocarbon fluids (such as pentane) may be utilized. Enhancements to this working fluid loop are described in patent application Ser. No. 12/396,336.

Referring again to FIG. 4, prime mover 428, which can be in the form of a radial turbine, supplies a the working fluid in a mostly vaporized state to condenser 420, where heat is rejected to external location (such as the atmosphere) and the working fluid vapor is condensed into a liquid state. Pump 426, forces the working fluid to heat exchanger 416, where it is fully or partially vaporized. At this point it can take one of several paths depending on the state of flow control valves 422, and 418. In one case, the working may be partially vaporized, and would subsequently flow from heat exchanger 416 to heat exchanger 412, where it would be fully vaporized, and hence to heat exchanger 408, where it would be superheated. Superheating refers to adding additional heat to a wet vapor (i.e. one containing microscopic liquid droplets) for the purpose of evaporating those droplets and adding more energy to the system. In another case, the working fluid may emerge from heat exchanger 436 in a fully vaporized state, thus flow control valves would be set to direct the flow from heat exchanger 416 to heat exchanger 408 where it can undergo superheating. In yet another case it may be required that a portion of the fluid emerging go from the heat exchanger 416, while the remainder go directly to heat exchanger 408. The optimal settings for the different flow options will be determined by a number of factors including temperatures of heat flows 406, 410, and source 414, as well as the nature of the demands for electricity 438, and output heat supply, 442. The saturated vapor which emerges from some combination of heat exchangers 408, 412, and 416 is used to drive prime mover 428.

Control unit, 424, is connected to sensor/control network 440. The network as portrayed does not reveal all possible connections to system energy conversion system components for the purpose of simplification. This network allows the control unit to monitor all parameters of the energy conversion system including but not limited too, component temperatures, turbine speeds, working fluid flow rates, and electrical output. This network also allows for control signals originating from the control system to be directed to various components including but not limited to pumps, turbines, flow control valves, generators, and grid interface electronics. All of these parameters are used as inputs by a control program which resides on control system 424. Control system 424 may be a microprocessor based computer or equivalent hardware allowing for complicated computing and control programs to be run. The control software uses the sensor inputs to keep the energy conversion system running within preset operational regions, and is capable of responding to changes, by sending appropriate control signals, in the needs of whatever facility is using the combined energy outputs. The control software can manage a number of sophisticated tasks including optimizing overall system efficiency, optimizing the efficiency of particular outputs (heating, electricity, cooling). It can also be connected to an external network (i.e. internet, satellite, or cellular networks) so that its operation may be remotely monitored and controlled.

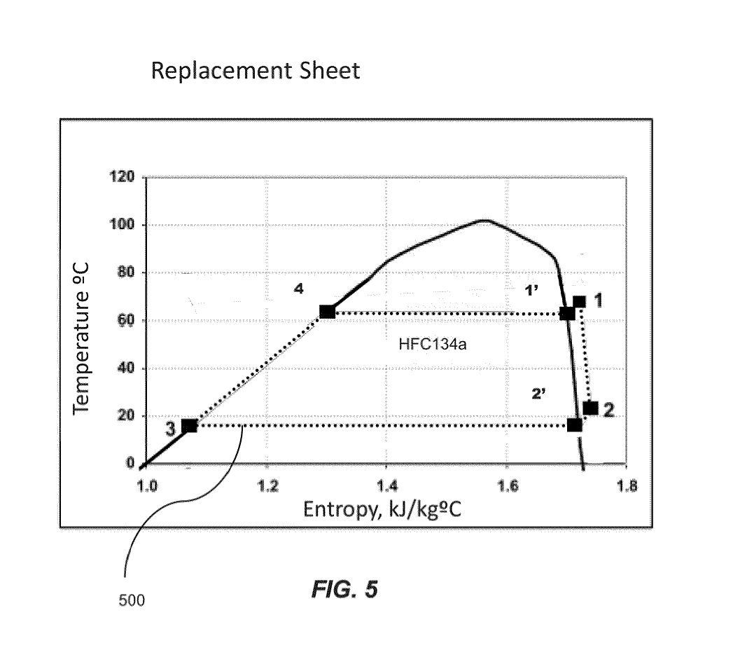

Referring now to FIG. 5, the temperature vs entropy plot shows a measure of the potential for the working fluid, HFC134a in this case, to do work. The total entropy is represented by the area contained within the dashed line 500. The path of dashed line 500 illustrates the states of the working fluid. Starting at state 3, the working fluid is in a fully condensed state. As heat is added, raising the temperature from state 3 to state 4, the entropy rises as the working fluid achieves the boiling point at state 4. Adding energy increases the entropy of the fluid until it reaches the saturated vapor state at state 1′. At this point, the working fluid vapor may be injected into the prime mover where the energy is extracted and the vapor moves to state 2′. Higher efficiencies can be obtained if the working fluid vapor is superheated from state 1′ to state 1. At this point the superheated vapor can also be injected into the prime mover where its energy is extracted, and the vapor reaches state 2. A condenser is used to reject waste heat from the exhaust vapor taking it from either state 2 or 2′ to state 3 where it arrive in the form of a fully condensed vapor. It can thus begin the cycle again.

In general, this system provides several advantages over converting energy from a single heat source. In one case a geothermal heat source with a temperature of 65° C. has useful energy which may be extracted, but not by using HFC134a as a working fluid because the characteristics of this fluid make it difficult to extract energy at temperatures below approximately 70° C. While it may be possible to raise the temperature of the geothermal heat source by drilling deeper into the reservoir, the expense and general impact of this drilling usually outweighs the benefits, thus the geothermal heat source has a fixed set of characteristics which must be accommodated. With the system described herein, it is possible to combine heat flows. Thus if the geothermal heat sources are above a new lower threshold, at least approximately 30° C., a single heat flow with sufficient temperature can thus be consolidated. This heat flow contains energy from both the geothermal heat source, and the combustible fuel. A fuel based heat source can be controlled, in a simple fashion, by adjusting the rate of combustion and/or the overall characteristics of the combustion portion of the energy conversion system. In this fashion the combustion heat source may be easily modified to permit economic extraction of the geothermal energy. The same ability to enhance a low temperature source applies to solar thermal sources as well which supply temperatures which vary according to the weather and time of day. The threshold at which these sources can provide useful energy is lowered, and therefore overall energy utilization is enhanced.

The same mechanisms apply if the flow rate of the geothermal heat source is too low. Even if the temperature is sufficiently high, say 85° C. or higher, the required flow rate may be beyond the reservoir's potential, or the expense of increasing it too costly. Again by consolidating multiple heat sources into one, the energy of the geothermal resource may be exploited to some extent without the need for modifications. Depending on prevailing weather patterns, a viable installation may result from the combination of a geothermal source and a solar thermal source without utilizing combustion to supply additional heat.

The ability to bring together more than two heat sources, for example solar, fuel, biomass, geothermal and others simplifies the issue of variations in the availability of each of the sources. These variations may occur for a number of reasons such as cloud cover (which impacts the incident solar flux), fuel prices, or external temperatures which impact the efficiency of heat rejection. Alternatively the facility which consumes the combined utility may have different demands during the day, at night, and during the year for electricity, heating, and cooling. The system can dynamically adapt to all of these variations and maintain the delivery of the desired electricity, heating, and cooling supply if it designed and operated properly.

The overall efficiency of energy conversion is greater because the consolidated energy sources are delivered in the form of electricity, heating, and cooling, potentially realizing >60% conversion in some cases. Additionally overall CO₂ emissions are lowered as a greater portion of the consolidated heat source may be extracted from renewable sources depending on the nature of the site on which the system is located.

Frequently, in cases where a geothermal heat source is being exploited for other purposes (recreational bathing for example), the facility which exploits the geothermal heat source (a hotel for example) incorporates infrastructure for the combustion of fuels to provide heating. Often the facility may also have the capability to support infrastructure for the collection of heat from solar radiation. Advantageously, in accordance with embodiments or the present invention, the heat from combustion and/or solar sources may be used to supplement the heat from the geothermal heat source to provide opportunities for enhanced energy extraction, utilization, and conversion from multiple heat sources.

In some cases the geo-fluid from a geothermal heat source emerges with sufficient temperature such that some portion of the geo-fluid emerges as steam, the steam may be used directly to drive a turbine for the purpose of generating electricity. The portion of the geo-fluid which emerges in liquid form is re-injected into the ground along with the condensed steam. In circumstances such as these, it may be advantageous to consolidate the waste heat from this process (liquid portion of the geo-fluid and the steam before it is condensed) with other heat sources. In this fashion additional power (electricity, heating, and cooling) may be derived with higher overall efficiency.

What is claimed is:

1. A method for using heat to perform work, comprising:
operating a first thermodynamic cycle wherein heat for a first working fluid is provided by combustion of a fuel-based (FB) energy source;
operating a second thermodynamic cycle wherein heat for a second working fluid is from a combination of a non-fuel-based (NFB) energy source and waste heat from the first thermodynamic cycle.

2. The method of claim 1, wherein the FB energy source comprises at least one of a fossil and a bio-fuel.

3. The method of claim 1, wherein the NFB energy source comprises at least one of a solar and a geothermal energy source.

4. The method of claim 1, wherein the first and second thermodynamic cycles comprise a Rankine cycle or a derivative thereof.

5. A method for using heat to perform work, comprising:
modifying an existing installation that utilizes a heat source for a specific purpose so that waste heat from said existing installation can be fed into a thermodynamic cycle, wherein said existing installation relies on at least one of combustion of a fuel-based (FB) energy source and a non-fuel based (NFB) energy source as the heat source; and
constructing a new installation to operate the thermodynamic cycle wherein a working fluid is heated by a combination of a non-fuel-based (NFB) energy source and the waste heat from the existing installation.

6. The method of claim 1, wherein the specific purpose is to heat a building, or to operate a first thermodynamic cycle.

7. The method of claim 5, wherein the FB energy source comprises at least one of a fossil and a bio-fuel.

8. The method of claim 5, wherein the NFB energy source comprises at least one of a solar and a geothermal energy source.

9. The method of claim 6, wherein the first and second thermodynamic cycles comprise a Rankine cycle or a derivative thereof.

10. A method for harnessing heat from a geothermal heat source, comprising:
using heat from a geo-fluid associated with the geothermal heat source to heat a working fluid for a first thermodynamic cycle; and
providing additional heat to heat said working fluid by using waste heat from combustion of fuel for a purpose consisting of at least one of heating a building, and operating a second thermodynamic cycle.

11. The method of claim 9, wherein the geo-fluid has a temperature below 65 degrees Celsius.

12. The method of claim 9, wherein the fuel is one of a fossil-fuel and a bio-fuel.

13. The method of claim 10, wherein the first and the second thermodynamic cycle is selected from the group consisting of a Rankin cycle, and a derivative of a Rankin cycle.

14. Apparatus to convert heat into energy, comprising:
a first sub-system to operate a first thermodynamic cycle to harness heat derived through combustion of a fuel-based (FB) energy source; and
a second sub-system to operate a second thermodynamic cycle to harness heat derived from a combination of a non-fuel-based (NFB) energy source and waste heat from the first sub-system.

15. The apparatus of claim 14, further comprising a thermal storage unit to store the waste heat for delivery to the second sub-system based on demand.

16. The apparatus of claim 14, further comprising a booster burner to provide supplementary heat to the second sub-system.

17. The apparatus of claim 14, wherein the first sub-system comprises an existing installation modified to feed the waste heat into the second sub-system.

18. The apparatus of claim 15, wherein the first and the second thermodynamic cycle is selected from the group consisting of a Rankine cycle, and a derivative of a Rankine cycle.

19. The apparatus of claim 14, wherein the FB energy source comprises at least one of a fossil and a bio-fuel.

20. The apparatus of claim 14, wherein the NFB energy source comprises at least one of a solar and a geothermal energy source.

21. A method for harnessing heat from a geothermal heat source, comprising:
using heat from a geo-fluid associated with the geothermal heat source to heat a working fluid for a thermodynamic cycle; and
providing additional heat to heat said working fluid by using heat from a non-fuel-based (NFB) source.

22. The method of claim 21, wherein the NFB source comprises a solar source.
